(19) United States
(12) Patent Application Publication
(10) Pub. No.: US 2014/0236317 A1
(43) Pub. Date: Aug. 21, 2014

(54) CONTROLLER, TIME CHART CREATION DEVICE, INFORMATION STORAGE MEDIUM, DEVICE CONTROL METHOD, AND TIME CHART CREATION METHOD

(71) Applicant: Kabushiki Kaisha Yaskawa Denki, Kitakyushu-shi (JP)

(72) Inventors: Takeshi NAGATA, Kitakyushu-shi (JP); Koji HARA, Kitakyushu-shi (JP); Yasufumi YOSHIURA, Kitakyushu-shi (JP); Kenichi HIROSE, Kitakyushu-shi (JP)

(73) Assignee: Kabushiki Kaisha Yaskawa Denki, Kitakyushu-shi (JP)

(21) Appl. No.: 14/182,279

(22) Filed: Feb. 17, 2014

(30) Foreign Application Priority Data
Feb. 15, 2013 (JP) 2013-028440

(51) Int. Cl. G05D 27/02

(52) U.S. Cl. CPC G05D 27/02
USPC 700/63

(57) ABSTRACT

A controller that controls a device on the basis of a time chart, which controls a servo axis on the basis of a velocity chart that plots a velocity of the servo axis and/or a position chart that plots a position of the servo axis, with respect to a time axis; executes return operation for returning the servo axis to an initial position set in the time chart in advance after operation described in the time chart has been executed; and executes regress operation for regressing to a start point of the time chart, and repetitively executing the time chart after the return operation has been completed.

The present disclosure contains subject matter related to that disclosed in Japanese Priority Patent Application JP 2013-028440 filed in the Japan Patent Office on Feb. 15, 2013, the entire contents of which are incorporated by reference.

### BACKGROUND OF THE INVENTION

1. Field of the Invention

The present invention relates to a controller, a time chart creation device, an information storage medium, a device control method, and a time chart creation method.

2. Description of the Related Art

JP 7-191717 A discloses an automatic control program creation device that automatically creates a ladder program from a time chart.

Also, JP 2003-228403 discloses that time charts of an input device and an output device are edited with the use of a personal computer, time chart data is compiled into a machine language, and the compiled machine language is transmitted to a processing device through an interface.

### SUMMARY OF THE INVENTION

According to one aspect of the present invention, there is provided a controller that controls a device on the basis of a time chart, which controls a servo axis on the basis of a velocity chart that plots a velocity of the servo axis and/or a position chart that plots a position of the servo axis, with respect to a time axis, executes return operation for returning to an initial position set in the time chart in advance after operation described in the time chart has been executed, and executes regress operation for regressing to a start time point of the time chart, and repetitively executing the time chart after the return operation has been completed.

Also, according to another aspect of the present invention, there is provided a time chart creation device that creates a time chart describing the operation of the above-mentioned controller, including a velocity/position chart creation unit configured to create the velocity chart and/or the position chart, and an initial position designation unit configured to designate the initial position with respect to the servo axis.

Further, according to still another aspect of the present invention, there is provided a tangible computer readable information storage medium, which stores computer program causing a computer to function as the above-mentioned time chart creation device.

According to yet still another aspect of the present invention, there is provided a device control method for controlling a device on the basis of a time chart, including controlling a servo axis on the basis of a velocity chart that plots a velocity of the servo axis and/or a position chart that plots a position of the servo axis with respect to a time axis, executing return operation for returning the servo axis to an initial position set in the time chart in advance after operation described in the time chart has been executed, and executing regression operation for regressing to a start time point of the time chart, and repetitively executing the time chart after the return operation has been completed.

Also, according to yet still another aspect of the present invention, there is provided a time chart creating method that creates a time chart describing the operation of the above-mentioned controller, including creating the velocity chart and/or the position chart, and designating the initial position with respect to each servo axis.

### BRIEF DESCRIPTION OF THE DRAWINGS

FIG. 1 is a schematic diagram illustrating an example of a device control system including a controller according to an embodiment of the present invention;

FIG. 2 is a block diagram illustrating a physical configuration of a time chart creation device;

FIG. 3 is a functional block diagram illustrating a controller and a time chart creation device according to a first embodiment of the present invention;

FIG. 4 illustrates an exemplary time chart which is created by the time chart creation device, and executed by the controller;

FIG. 5 is a diagram illustrating real operation of a device control system according to this embodiment, in the time chart illustrated in FIG. 4;

FIG. 6 is a flowchart illustrating operation when the controller according to the first embodiment executes the time chart;

FIG. 7 is a functional block diagram of a controller and a time chart creation device according to a second embodiment of the present invention;

FIG. 8 is a time chart in which a return waveform, a regress instruction, and a contact initialization instruction are added;

FIG. 9 is a flowchart illustrating operation when the time chart creation device according to the second embodiment creates the time chart; and

FIG. 10 is a flowchart illustrating operation when the controller according to the second embodiment executes the time chart.

### DESCRIPTION OF THE EMBODIMENTS

According to the standpoint of the present inventors, a device to be controlled by a machine control program which is executed by a controller is required to repetitively conduct a sequence of operation. When a PLC (programmable logic controller) that executes a sequence program such as a general ladder program is used as a controller, the program is described so that the sequence of operation starts upon receiving a timing signal from the outside, or the sequence of operation is repetitively conducted to realize repetitive operation. However, how the repetitive control is described, and how the repetitive control is executed when operation timing of the respective devices is to be controlled on the basis of the time chart without depending on a sequence program such as the ladder program, have not been considered up to now.

Under the circumstances, as a result of earnestly researching and developing a technology for simple creation of the time chart that can realize the above repetitive operation, the present inventors have conceived a novel and creative time chart creation device. Hereinafter, the time chart creation device will be described according to embodiments in detail.

### <Device Control System According to Embodiment>

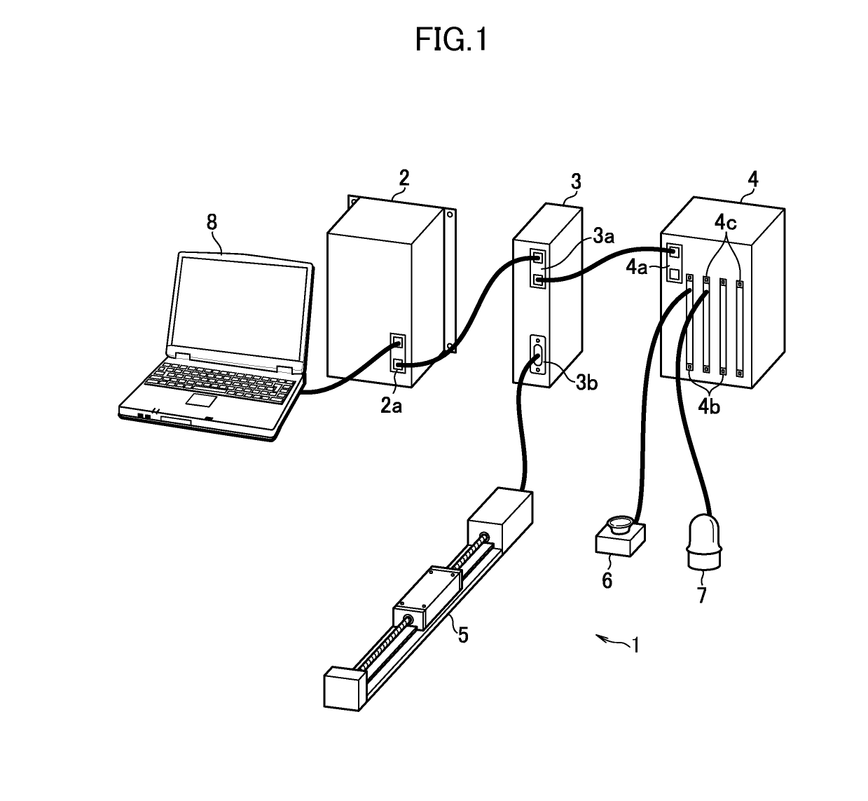

FIG. 1 is a schematic diagram illustrating an example of a device control system 1 including a controller 2 according to an embodiment of the present invention. In the following description, a first embodiment and a second embodiment will be described, separately. However, FIG. 1 is common to those embodiments. Referring to FIG. 1, the device control system 1 includes the controller 2, a servo controller 3, an I/O unit 4, a linear slider 5, a switch 6, and a lamp 7, and a time chart creation device 8 is connected to the controller 2.

The controller 2 is configured to control the overall device control system 1, and in this embodiment, controls at least one device on the basis of a time chart. In the present specification, the time chart means information describing the operation of a device to be connected to the controller 2 with respect to a time axis, and its expression form is no object. Also, a servo axis such as the linear slider 5 which is driven through the servo controller 3, and input/output devices such as the switch 6 or the lamp 7 are examples of the device to be controlled by the controller 2. The time chart to be executed by the controller 2 is created by the time chart creation device 8, input to the controller 2 in the form of electronic data, and stored therein. The controller 2 is equipped with an information communication connector 2a.

The servo controller 3 is configured by integrating a servo amplifier and a control circuit for controlling a servo motor together, and is equipped with an information communication connector 3a for connection to other devices including the controller 2, and a servo connector 3b for connection to a servo mechanism such as the linear slider 5. In this example, the servo connector 3b is connected with the linear slider 5 as an example of the servo axis.

The linear slider 5 is a mechanism in which a servo motor, an encoder, a ball screw coupled to an output shaft of the servo motor, and a slide table guided by a linear guide and driven by the ball screw are integrated together. The slide table is driven according to an output from the servo controller 3. In the present specification, the servo axis is a general expression for a mechanism driven with the servo motor as a power source, distinguished mainly by a use of the servo motor.

The I/O unit 4 is configured to include an information communication connector 4a for connection to other devices including the controller 2, and a large number of input/output contacts for connection to the input/output devices. The I/O unit 4 is equipped with input connectors 4b and output connectors 4c as the input/output contacts, and the input connectors 4b and the output connectors 4c include large numbers of contacts for input or output (called “input contacts” and “output contacts”, respectively), respectively. The I/O unit 4 transmits input states of the input contacts included in the input connectors 4b to the controller 2 through the information communication connector 4a. Also, the I/O unit 4 controls states of the output contacts included in the output connectors 4c according to an instruction transmitted from the controller 2 through the information communication connector 4a. The I/O unit 4 functionally serves to add external input/output contacts to the controller 2. In this embodiment, as an example of the input/output device, the switch 6, which is a normally opened (that is, A contact) mechanical switch, is connected with the input connector 4b of the I/O unit 4 and the lamp 7 is connected with the output connector 4c. In this example, the input/output contacts represent contacts for inputting or outputting information using electrical states of a high impedance and a low impedance. Also, the input/output devices represent devices connected to the controller 2 by the input/output contacts.

In this embodiment, as illustrated in FIG. 1, the controller 2, the servo controller 3, and the I/O unit 4 are communicatable with each other by cascade connection of the information communication connectors 2a, 3a, and 4a through cables.

The time chart creation device 8 supports a user to create the time chart which is executed in the controller 2. Also, in this embodiment, the time chart creation device 8 acquires information on an operating status from the controller 2, and can display the information for the user, for the purpose of monitoring a state of the device control system 1. The time chart creation device 8 maybe configured by a dedicated device, but is realized by execution of a computer program functioning as the time chart creation device 8 with the use of a general computer as shown in the figure. The computer program may be stored in tangible computer readable information media such as a variety of optical disks or semiconductor memories, and it is preferable that the computer program is installed into the computer from the medium. Alternatively, the computer program may be downloaded into the computer from a variety of information communication networks such as the internet. This may be further realized by so-called cloud computing in which the function is provided to the computer by a server which is located at a remote place through the information communication network.

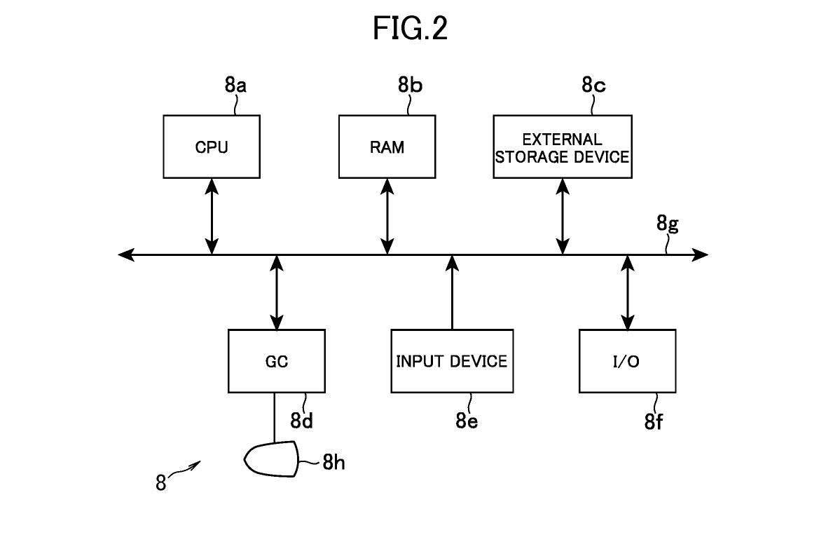

FIG. 2 is a block diagram illustrating a physical configuration of the time chart creation device 8. The time chart creation device 8 is a general computer, in which a CPU (central processing unit) 8a, a RAM (random access memory) 8b, an external storage device 8c, a GC (graphics controller) 8d, an input device 8e, and an I/O (input/output) 8f are connected to each other by a data bus 8g to mutually transfer an electric signal. In this example, the external storage device 8c is a device that can statically record information such as an HDD (hard disk drive) or an SSD (solid state drive). Also, a signal from the GC 8d is output to a monitor 8h for allowing the user to visually recognize an image, such as a CRT (cathode ray tube) or a so-called flat panel display, and displayed as an image. The input device 8e is a device to which the user inputs information, such as a keyboard, a mouse, or a touch panel. The I/O 8f is an interface for allowing the time chart creation device 8 to exchange information with an external device, in this example, with the controller 2.

In the above description, and FIGS. 1 and 2, other detailed configurations and wirings unnecessary for description of this embodiment, for example, the connection of a power line and ground line is omitted for simplification of the description and illustration. Also, a connection mode, the kind of the connector, and the kind and number of a device to be controlled are not particularly limited, and various configurations are conceivable. Further, in operating the device control system 1, the controller 2 does not always need to be connected with the time chart creation device 8, and if the time chart is transferred to the controller 2, the device control system 1 is operable even if the time chart creation device 8 is not provided. Also, the time chart creation device 8 does not always need to be connected to the controller 2, and the time chart can be created by the time chart creation device 8 alone.

<Configuration of Controller and Time Chart Creation Device according to First Embodiment>

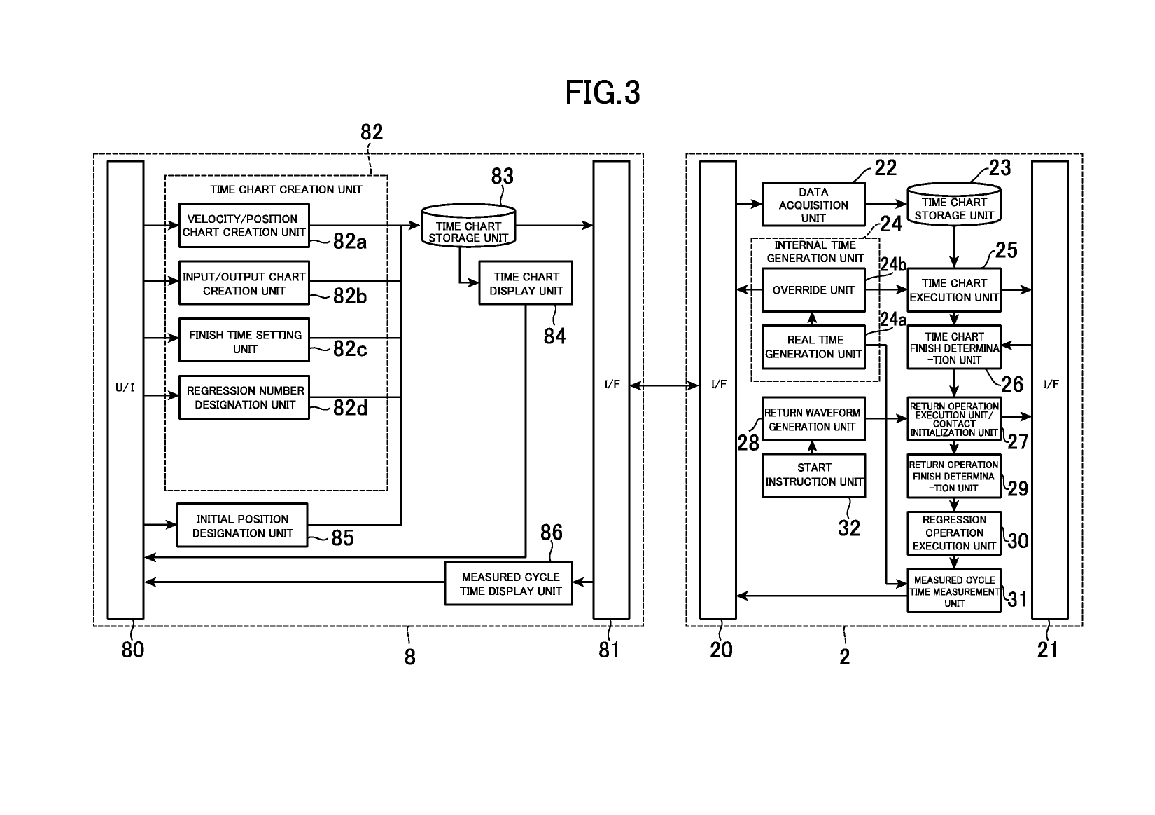

FIG. 3 is a functional block diagram illustrating the controller 2 and the time chart creation device 8 according to the first embodiment of the present invention.

The controller 2 includes an interface 20 connected to the time chart creation device 8 side, and an interface 21 connected to each device side to be controlled. The time chart created by the time chart creation device 8 is acquired by a data acquisition unit 22 through the interface 20, and stored in a time chart storage unit 23 in the form of electronic data.

An internal time generation unit 24 generates an internal time which is a time defining timing at which the controller 2 executes the operation of the respective devices which is described in the time chart. That is, the internal time called in the present specification is used as a time indicated on the time axis of the time chart.

The internal time is generated by a real time generation unit 24a having an appropriate clock circuit and the like, which are included in the internal time generation unit 24. Also, the internal time is generated so that a progression speed of the real time that progresses in correspondence to an actual time is adjusted according to an appropriate override coefficient by an override unit 24b.

In this example, the override coefficient indicates a ratio of the progression speed of the internal time to the progression time of the real time. For example, if the override coefficient is 0.8, the internal time slowly progresses at a speed of 80% to the real time, and if the override coefficient is 1.2, the internal time rapidly progresses at a speed of 120% to the real time. If the override coefficient is 1, the progression time of the internal time matches the progression time of the real time. The override coefficient is set by the time chart creation device 8 through the interface 20, or by the user with the use of an arbitrary device such as an appropriate teaching pendant. Also, the generated internal time may be output to the time chart creation device 8 through the interface 20 in order to monitor the operation of the respective devices.

On the basis of the internal time generated by the internal time generation unit 24, a time chart execution unit 25 interprets the operation of the respective devices described in the time chart stored in the time chart storage unit 23, and outputs control signals to the respective devices through the interface 21 in order to execute the interpreted operation. The basic operation of the time chart execution unit 25 is outputting the control signals for operating the operation described in the time chart when the internal time arrives at a time point of the description therein.

A time chart finish determination unit 26 determines whether the operation described in the time chart is finished, or not. This determination is not to determine that the internal time arrives at a scheduled finish time, but to determine that the real operation of the respective devices is finished. Therefore, the time chart finish determination unit 26 determines that the operation described in the time chart has been finished if at least any one of that a positioning completion signal of the servo axis is output, and that a state of the input/output contact matches a scheduled state when the time chart is finished, is satisfied, in addition to that the internal time arrives at the scheduled finish time. The states of the respective devices are acquired through the interface 21, and in this embodiment, the timechart finish determination unit 26 determines that the operation described in the time chart is finished if all of that all of the servo axes output the positioning completion signals, and that the state of the input/output contact matches the scheduled state at the time of finishing the time chart are satisfied. In this embodiment, because the description of the return operation which will be described later is not included in the time chart, the time chart finish determination unit 26 determines that the operation described in the time chart has been finished with the finish of the operation explicitly created by the user. Also, the time chart finish determination unit 26 counts up the number of regression. When the number of regression operation, that is, the number of repetitive executions of the time chart is designated by the user, if the number of regression operation arrives at a designated value made by the user, the time chart finish determination unit 26 finishes the control of the device without conducting subsequent operation of a return operation execution unit/contact initialization unit 27.

Upon receiving the finish determination by the time chart finish determination unit 26, the return operation execution unit/contact initialization unit 27 executes the return operation for returning the servo axis to the initial position specific to the time chart at specified velocity and acceleration. The return operation execution unit/contact initialization unit 27 also transmits a control signal for initializing, particularly, the state of the output contact among the input/output contacts to a scheduled initial state at the time of starting the time chart, to the interface 21. The specified velocity and acceleration as well as the initial position used in this example are set by the time chart creation device 8 through the interface 20, or by the user with the use of an arbitrary device such as an appropriate teaching pendant. Also, the initial position represents a position of the servo axis set in each time chart in advance, and may be different from a physical origin position of the servo axis. That is, the initial position is a position set independent of the origin position. In this embodiment, the return operation execution unit/contact initialization unit 27 returns all of the servo axes to the initial position. The conditions for executing the return operation by the return operation execution unit/contact initialization unit 27 are not limited to only the finish determination by the time chart finish determination unit 26, but another condition may be added. The output of the positioning completion signal of the servo axis is at least one of the execution conditions of the return operation.

A return waveform generation unit 28 automatically generates a return waveform which is a waveform used by the servo axis in the return operation which is executed by the return operation execution unit/contact initialization unit 27, that is, a profile of the velocity or position. In the present specification, the automatic generation represents that the controller 2 generates the return waveform without allowing the user to designate the waveform. The return operation execution unit/contact initialization unit 27 controls the servo axis according to the return waveform generated by the return waveform generation unit 28 to execute the return operation. The timing at which the return waveform generation unit 28 generates the return waveform may be a time point when the return operation is conducted by the return operation execution unit/contact initialization unit 27, or the return waveform may be generated in advance on the basis of the time chart stored in the time chart storage unit 23.

In generating the return waveform, the return waveform generation unit 28 refers to the specified velocity and acceleration as well as initial position. Now, the return waveform generation unit 28 will be described in more detail. For example, the velocity, the acceleration, and the initial position are set for the servo axis. The velocity and the acceleration may be, for example, rated velocity and acceleration of the servo axis, or may be set by the user in advance. Also, the initial position is set to be specific to the time chart by the user in advance as will be described later. The initial position may match the origin position of the servo axis. However, because the origin position of the servo axis is specific to the servo axis, it is desirable to set the initial position to another appropriate value for the purpose of creating the time chart or reducing a time cycle of execution. On the other hand, the position of the servo axis at the time of finishing the execution of the time chart is represented by the time chart, or can be calculated. Under the circumstances, the return waveform generation unit 28 can automatically generate the waveform of the return operation according to the position at the time of finishing the execution and the initial position, and the specified velocity and acceleration. In this situation, when the servo axis is a multi-rotary shaft, the return waveform generation unit 28 may set a rotating direction thereof in advance. Also, when a plurality of axes is present, and may interfere with each other, interference or noninterference conditions maybe set in advance, and the return waveform generation unit 28 can generate the waveform of the return operation so as to satisfy those conditions. As in this embodiment, when the return waveform generation unit 28 generates the return waveform at timing when the return operation is conducted, the return waveform generation unit 28 may further collect information on the device to be controlled such as the servo axis, and reflect the information on the return waveform. That is, the return waveform generation unit 28 can generate the return waveform with the use of a more accurate present position instead of the position of the servo axis at the time of finishing the execution represented on or calculated from the time chart, thereby being capable of conducting more precise and rapid return operation.

A return operation finish determination unit 29 determines whether the return operation executed by the return operation execution unit/contact initialization unit 27 has been finished, or not. This determination is also to determine that the real operation of the respective devices is finished, and the conditions of the finish determination are that the positioning completion signal of the servo axis has been output. In this embodiment, the determination conditions are that all of the servo axes output the positioning completion signals.

Upon receiving the finish determination by the return operation finish determination unit 29, a regression operation execution unit 30 conducts the regression operation for regressing an execution position of the time chart to a start time point thereof so as to repetitively execute the time chart. Any specific method is applicable to the regression operation, in this embodiment, the regression operation is conducted by rewriting the internal time to a time point of 0 second which is the start time of the time chart. The execution conditions of the regression operation may be added with another condition, and the output of the positioning completion signal of the servo axis is at least one of the execution conditions of the regression operation.

A measured cycle time measurement unit 31 monitors areal time generated by the real time generation unit 24a, measures a measured cycle time which is a time from the start time point of the time chart to the execution time point of the regression operation by the regression operation execution unit 30 for each execution of the time chart, and outputs the measured cycle time to the time chart creation device 8 through the interface 20. A start instruction unit 32 operates when the execution of the time chart starts, or when the controller 2 is powered on to boot up. Further, the start instruction unit 32 may operate when the controller 2 reboots by a reset switch or a reset signal. The start instruction unit 32 instructs the return waveform generation unit 28 to generate the return waveform for moving each servo axis from the present position to the initial position, and the return operation execution unit/contact initialization unit 27 executes the return operation according to the generated return waveform, and initializes the contacts. With the above configuration, when the controller 2 starts the time chart execution, boots up, or reboots, each servo axis and the output contact become in a state when the time chart starts, and the time chart is executable immediately. The operation of the start instruction unit 32 may be also conducted when a new time chart is transferred from the time chart creation device 8 to the controller 2, or when an instruction is received from the time chart creation device 8 side.

The time chart creation device 8 includes a user interface 80, and an interface 81 connected to the controller 2. The user interface 80 physically corresponds to the input device 8e and the monitor 8h in FIG. 2, and the interface 81 corresponds to the I/O 8f in FIG. 2.

A time chart creation unit 82 receives necessary information from the user with the use of a GUI (graphical user interface) displayed on the user interface 80, and creates the time chart. In this embodiment, the time chart creation unit 82 includes a velocity/position chart creation unit 82a, an input/output chart creation unit 82b, a finish time setting unit 82c, and a regression number designation unit 82d.

The velocity/position chart creation unit 82a creates a velocity chart which is a chart that plots the velocity of the servo axis, or a position chart which is a chart that plots the position of the servo axis on the basis of an input from the user. In general, the position chart is obtained if the velocity chart is integrated with respect to time. Therefore, the velocity/position chart creation unit 82a may create any one of the velocity chart and the position chart. However, in this embodiment, the velocity/position chart creation unit 82a can create both of those charts according to an instruction from the user.

The input/output chart creation unit 82b creates the chart that plots the operation of the input/output device, that is, the state of the input/output contacts on the basis of an input from the user. This chart describes a change in predicted input with respect to the time axis for the input device, and describes a change in output from the controller 2 with respect to the time axis for the output device.

It is preferable that the velocity/position chart creation unit 82a and the input/output chart creation unit 82b can designate the respective charts to start the operation of the device described in the respective charts in conjunction with a change in a state of another device. With the above designation, the operation associated with a plurality of devices such that a switch is depressed to start the servo axis is described. A relationship that the operation of one device is associated with a change in the state of another device may be called, for example, “link” or “association”.

The finish time setting unit 82c sets a time at which a sequence of operation described in the time chart is finished by user's designation. The operation of the respective devices described in the time chart is repetitively executed with one cycle from a time point of 0 seconds which is the start time to the finish time. The finish time set in this example is a predetermined finish time on the time chart, and the finish time point of the operation in one cycle does not always match the finish time during the real operation.

The regression number designation unit 82d designates how many times the operation of the respective devices described in the time chart is repetitively executed, that is, the number of regression operation on the basis of an input from the user. It is preferable that the number of regression operation can be designated as infinitude.

The charts created by the velocity/position chart creation unit 82a and the input/output chart creation unit 82b, the finish time set by the finish time setting unit 82c, and the number of regression operation designated by the regression number designation unit 82d are stored in a time chart storage unit 83 as electronic data constituting the time charts. Also, the time charts thus created are read by a time chart display unit 84, and displayed on the user interface 80 for the user so that the contents can be always confirmed.

An initial position designation unit 85 designates the initial position for each servo axis on the basis of an input from the user. The initial position is a scheduled position of the servo axis at the time of starting the execution of the time chart, and does not always match the origin position of the servo axis as described above. Because the initial position is designated to be specific for each time chart, the initial position is stored in the time chart storage unit 83 together with the corresponding time chart.

Information including the time chart stored in the time chart storage unit 83 is transferred to the controller 2 through the interface 81 if necessary.

A measured cycle time display unit 86 receives the measured cycle time measured by the measured cycle time measurement unit 31 of the controller 2 through the interface 81, and displays the measured cycle time on the user interface 80. The user can know a time necessary for the operation of one cycle when the device is actually operated while viewing the above display.

<Operation of Device Control System according to First Embodiment>

Subsequently, the operation of the device control system 1 according to this embodiment will be described with an example of a specific time chart.

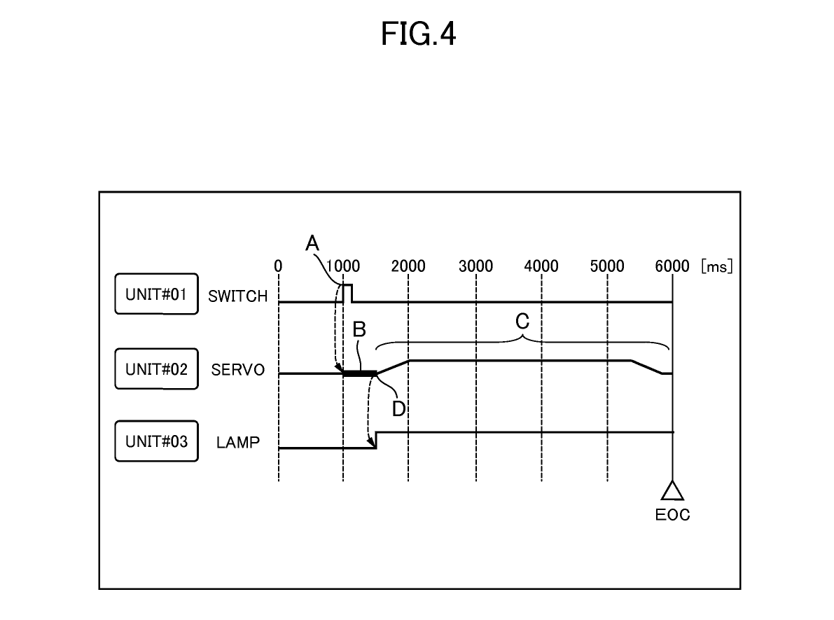

FIG. 4 illustrates an exemplary time chart which is created by the time chart creation device 8, and executed by the controller 2. In the time chart, the axis of abscissa is a time axis, and the axis of ordinate sequentially represents the respective devices to be controlled. Curves corresponding to the respective devices represent states of the respective devices. Since the switch 6 indicated as “UNIT#01”, and the lamp 7 indicated as “UNIT#03” are the input/output devices, a case in which the curve is at an upper position means a low impedance (connection), and a case in which the curve is at a lower position means a high impedance (disconnection). Also, a curve corresponding to the servo axis indicated as “UNIT#02”, in this case, the linear slider 5 represents a velocity of the slider.

The intended operation in this time chart is that the switch 6 turns on at a time point when 1000 ms elapses from the start (point A in the figure), a timer starts in conjunction with a state change of the switch 6, it waits for 500 ms which is a set time (thick line B in the figure), the servo axis (linear slider 5) is moved by a given movement amount (zone C in the figure), and the lamp 7 is turned on in conjunction with a movement start time point (point D in the figure) of the servo axis. The finish time of the time chart is set to a time point of 6000 ms which is the same time as a movement finish of the servo axis, and indicated as an EOC (end of control) in the figure.

Dashed arrows illustrated in the time chart indicates that another device operates in conjunction with the operation of one device, that is, a state change thereof, that is, link (or association). Notation using the arrows is exemplary, and how to express that another device operates in conjunction with the state change of one device is arbitrary. When the time chart is visually shown as in FIG. 4, the conjunction may not always be explicitly shown. It is enough that the above conjunction of the operation is made so that certain operation of one device is associated with certain operation of another device in some manner. Also, the time chart illustrated in FIG. 4 exemplifies a case in which the start of the operation of the servo axis is associated with the state change of the switch 6. However, this association maybe conducted between the respective servo axes or the respective devices other than the servo axes. Also, the finish of the operation of the servo axis may be associated with the state change of another device. Further, the state change of one device may be interlocked with another operation of the same one device per se. For example, when the servo axis starts to move in a reverse direction immediately at timing of movement finish after the servo axis moves by a given amount in a forward direction, the state change of one device is interlocked with another operation of the same one device per se.

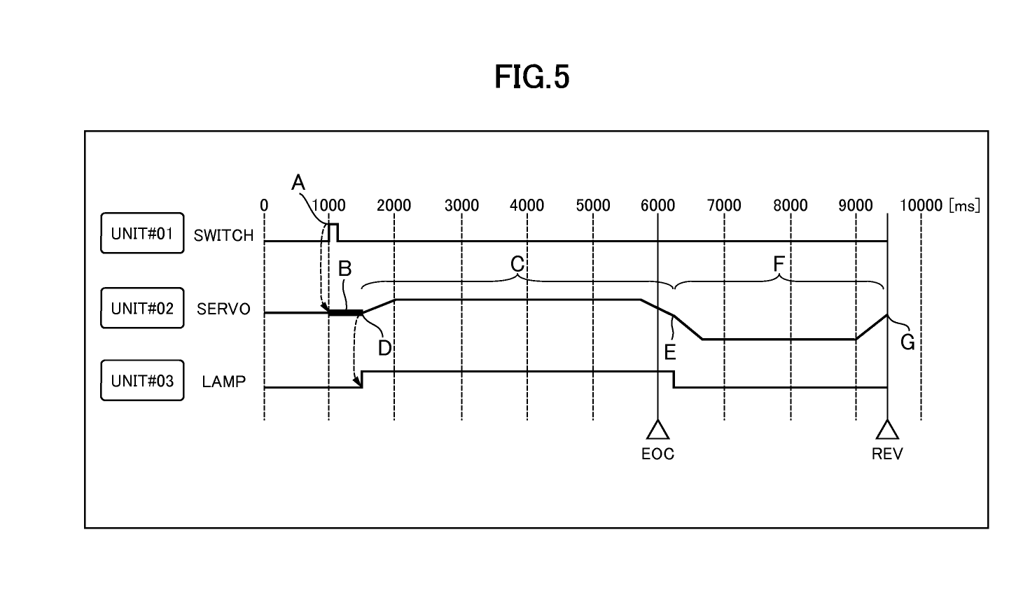

FIG. 5 is a diagram illustrating an example of real operation of the device control system 1 according to this embodiment, in the time chart illustrated in FIG. 4. The respective curves illustrated in the figure represent the actual operations of the switch 6 which is the actual device, the linear slider 5 which is the servo axis, and the lamp 7 in the form of a time chart.

The time chart execution unit 25 of the controller 2 interprets the operation of the respective devices described in the time chart illustrated in FIG. 4, and sequentially executes the operation. At a stage of a point D in FIG. 5, the operation of the respective devices is conducted as illustrated in the time chart. After 500 ms which is a time when the switch 6 turns on, the linear slider 5 starts to move, and at the same time, the lamp 7 turns on.

At a time point when the internal time arrives at 6000 ms as it is, the finish time arrives on the time chart. In this situation, the time chart finish determination unit 26 determines whether the operation described in the time chart has been finished, or not. In this example, the operation of the linear slider 5 is not completed, and a positioning completion signal indicative of the operation completion is not output from the servo controller 3. For that reason, the time chart finish determination unit 26 determines that the operation described in the time chart has not yet been finished.

A time further elapses, the linear slider 5 stops at a target position at a time point of a point E in the figure, and the positioning completion signal is output. Because the switch 6 is off which is a state at the finish time point on the time chart, the time chart finish determination unit 26 determines that the operation described in the time chart has been finished, at that time. Further, the time chart finish determination unit 26 counts the number of regression operation, and finishes the control of the device if the number of regression operation reaches the designated number of regression operation. For that reason, in this embodiment, the states of the respective devices when the control of the devices has been finished match states of those at a time point when the operation explicitly shown in the time chart by the user is finished.

If the time chart finish determination unit 26 determines that the operation described in the time chart has been finished, and the number of regression operation also does not reach the designated number of regression operation, the return operation is executed on the linear slider 5 by the return operation execution unit/contact initialization unit 27, and the output contact is also initialized. In an example of FIG. 5, a waveform represented in a zone F is the return waveform, and generated by the return waveform generation unit 28 as a waveform for moving the linear slider 5 to the initial position by the specified velocity and acceleration. Also, the return operation execution unit/contact initialization unit 27 switches the output contact, in this case, an output to the lamp 7 from an on-state to an off-state which is the initial state.

A time further elapses, the linear slider 5 stops at the initial position, and at a time point of a point G where the positioning completion signal is output, the return operation finish determination unit 29 determines that the return operation has been completed. As a result, the regression operation execution unit 30 executes the regression operation. A time point of this regression operation is indicated as REV in the figure. With the above regression operation, the internal time is again turned back to the time point of Oms, and the operation described in the time chart is again executed.

Also, a real time from a time (Oms at the internal time) when the execution of the time chart starts to a time (9500 ms at the internal time in this case) when the regression operation is executed is measured by the measured cycle time measurement unit 31, and output to the time chart creation device 8 through the interface 20. In the example of FIG. 5, if the override coefficient is 1, the measured cycle time is 9500 ms.

As described above, since the controller 2 conducts the return operation to the initial position, the controller 2 can repetitively execute the control of the device on the basis of the time chart. Further, since the controller 2 automatically generates the return waveform as described above, conducts the return operation and the regression operation, and puts the output signal of the output contact into the initial state, the user easily repeats the sequence of operation described in the time chart without particularly being aware of the states of the respective devices at the time of finishing the time chart. Also, since the initial position of the servo axis can be set independently of the origin position, the position of the servo axis at the time of starting the time chart can be arbitrarily set without being limited to the origin position. Also, since the return operation and the regression operation are conducted after the positioning completion signal of the servo axis has been output, the return operation and the regression operation are not executed during the operation of another servo axis, and an unexpected situation such that the respective devices interfere with each other is prevented.

In the above description, even after the time point (point E in the figure) when the time chart finish determination unit 26 determines that the operation described in the time chart has been finished, the internal time progresses, the return operation is conducted according to the return waveform illustrated in the zone F. Alternatively, the time chart finish determination unit 26 may stop the progression of the internal time at the time of determining that the operation described in the time chart has been finished. In the return operation, the return operation execution unit/contact initialization unit 27 may merely output a signal for indicating positioning to the initial position to the servo controller 3. In this case, the return waveform may not be generated with addition to the time chart. The return waveform is determined according to parameters such as the acceleration and the velocity used when the servo controller 3 conducts the positioning to the initial position.

<Operation Flow of Controller according to First Embodiment>

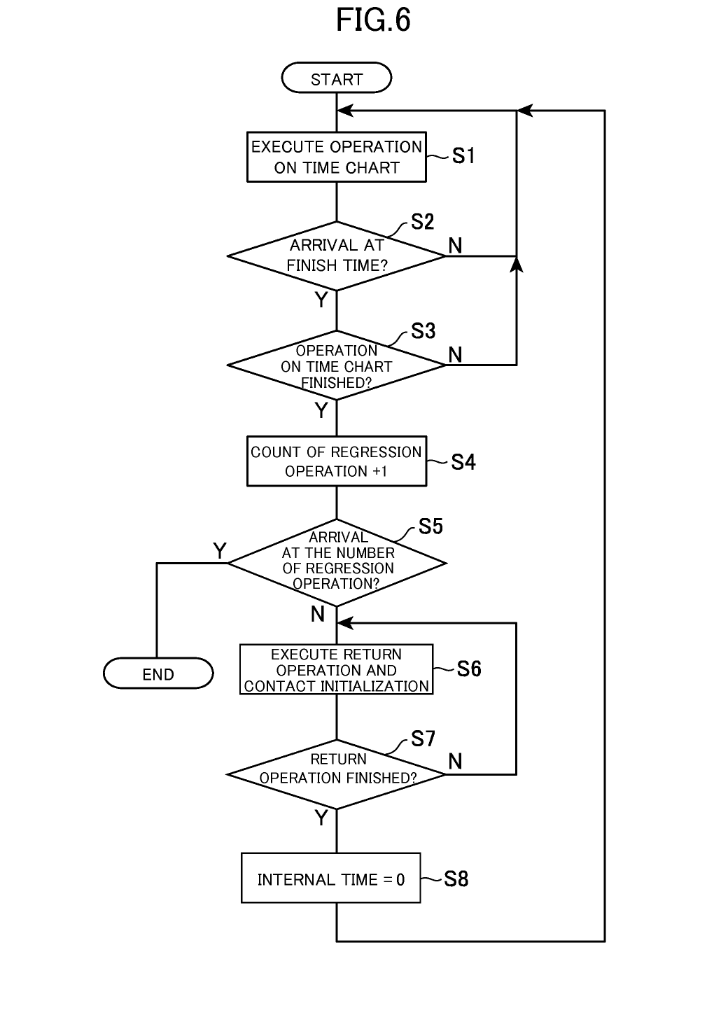

FIG. 6 is a flowchart illustrating operation when the controller 2 according to this embodiment executes the time chart.

When starting the execution of the time chart, the controller 2 interprets and executes the operation described in the time chart according to the internal time, in Step S1. Then, the controller 2 determines whether the internal time arrives at the finish time, or not, in Step S2, and if not, the controller 2 progresses the internal time, and returns to Step S1.

When the internal time arrives at the finish time, the controller 2 proceeds to Step S3, and determines whether the operation on the time chart has been finished, or not. In this example, controller 2 determines that the operation on the time chart has been finished because the state of the input contact matches the state at the finish time in the time chart and the servo axis outputs the positioning completion signal. If the operation on the time chart has not been finished, the controller 2 returns to Step S1 whereas if finished, the controller 2 proceeds to Step S4.

In Step S4, the count of the regression operation is incremented by 1. In subsequent Step S5, if the count reaches the specified number of regression operation, the controller 2 finishes the operation. If the count does not reaches the number of regression operation, the controller 2 proceeds to Step S6, and executes the return operation and the contact initialization. In subsequent Step S7, the controller 2 determines whether the return operation has been finished, or not. The finish of the return operation is determined by outputting the positioning completion signal by the servo axis. If the return operation is not finished, the controller 2 progresses the internal time, and returns to Step S6.

If the return operation is finished, the controller 2 proceeds to Step S8, and resets the internal time to Oms which is the start time. The controller 2 further returns to Step S1, and repeats the execution of the time chart.

In the above description, the time chart finish determination unit 26 counts the number of regression operation, and if the number of regression operation reaches the designated number of regression operation, the control of the device is finished. With the above operation, even when the time chart is repetitively executed, the states of the respective devices at the time of finishing the control match the state at the time of finishing the operation explicitly shown in the time chart by the user. Altenatively, the regression operation execution unit 30 counts the number of regression operation, and if the number of regression operation reaches the designated number of regression operation, the regression operation execution unit 30 may finish the control of the device. In this case, since the finish of the control is conducted after the return operation and the contact initialization operation, the states of the respective devices at the time of finishing the control match the initial state at the time of starting the time chart.

<Configurations of Controller and Time Chart Creation Device according to Second Embodiment>

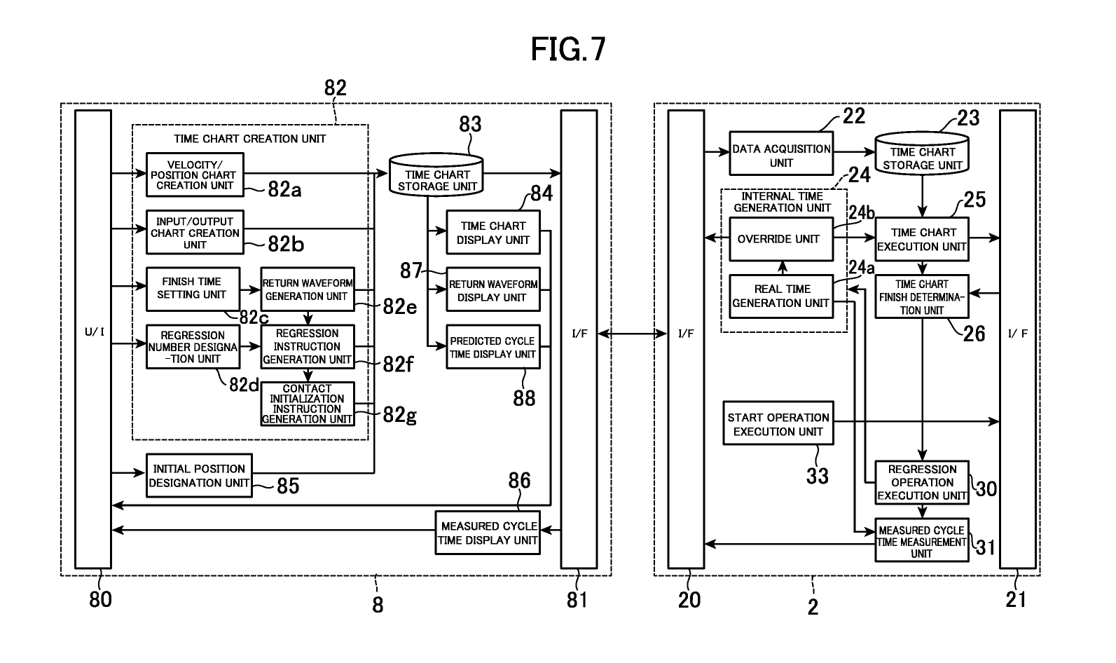

FIG. 7 is a functional block diagram of the controller 2 and the time chart creation device 8 according to a second embodiment of the present invention. In this embodiment, parts common to those in the previous embodiment are denoted by identical reference numbers, and a repetitive description will be omitted. Main differences between the controller 2 according to this embodiment and the controller 2 according to the previous embodiment reside in that the return operation execution unit/contact initialization unit 27, the return operation finish determination unit 29, and the return waveform generation unit 28 are omitted in the controller 2 of this embodiment, and the start instruction unit 32 is replaced with a start operation execution unit 33. Also, main differences between the time chart creation device 8 according to this embodiment and the time chart creation device 8 according to the previous embodiment reside in that a return waveform generation unit 82e, a regression instruction generation unit 82f, a contact initialization instruction generation unit 82g, a return waveform display unit 87, and a predicted cycle time display unit 88 are newly provided.

Parts of the controller 2 in this embodiment different from those in the previous embodiment will be described below.

The time chart finish determination unit 26 determines whether the operation described in the time chart has been finished, or not, in particular, the real operation of the respective devices has been finished, like the above embodiment. However, in this embodiment, because the description of the return operation is included in the time chart, the time chart finish determination unit 26 determines that the operation described in the time chart has been finished with the completion of the return operation, in addition to that the operation explicitly created by the user has been finished.

Upon receiving the finish determination by the time chart finish determination unit 26, a regression operation execution unit 30 conducts the regression operation for regressing an execution position thereof to a start time point of the time chart so as to repetitively execute the time chart. Similarly, in this embodiment, the regression operation is conducted by rewriting the internal time to a time point of 0 seconds which is the start time of the time chart. Also, in this embodiment, the regression operation execution unit 30 counts up the number of regression operation, and finishes the control of the device without conducting the regression operation if the number of regression operation arrives at the designated value made by the user.

Parts of the time chart creation device 8 in this embodiment different from those in the previous embodiment will be described below.

The return waveform generation unit 82e generates a return waveform which is a waveform of the return operation for returning the servo axis to the initial position at the specified velocity and acceleration after the finish time set by the user, and after the time point when the operation of the respective devices is finished on the time chart, and adds the generated return waveform to the time chart. The generation of the return waveform by the return waveform generation unit 82e may be conducted when the creation of the explicit operation by the user has been finished, and the finish of creation of the time chart is instructed, when an instruction is given from the user to generate the return waveform, or when the time chart is transferred to the controller 2. The return waveform generation unit 82e can generate the return waveform as in the return waveform generation unit 28 of the previous embodiment.

In adding the return waveform, the regression instruction generation unit 82f adds a regression instruction for indicating the regression operation at the time of finishing the return operation added to the time chart by the return waveform generation unit 82e.

In adding the return waveform, the contact initialization instruction generation unit 82g adds, to the time chart, a contact initialization instruction which is an instruction for initializing, particularly, the state of the output contact among the input/output contacts to the scheduled initial state at the time of starting the time chart after a time point when the operation of the respective devices is finished after the finish time set by the user, and before the regression instruction. In this embodiment, the contact initialization instruction is added together with the return operation.

The return waveform display unit 87 displays the return waveform generated by the return waveform generation unit 82e on the user interface 80 for the user to confirm the return operation.

The predicted cycle time display unit 88 displays a predicted cycle time which is a time from a start time of the time chart to a regression instruction generated by the regression instruction generation unit 82f on the time chart on the user interface 80 for the user. The predicted cycle time is a time necessary for a sequence of operation in the device control system 1 which is expected assuming that the operation described in the time chart is conducted ideally (that is, according to the description in the time chart). The predicted cycle time display unit 88 may be also disposed in the time chart creation device 8 according to the first embodiment (refer to FIG. 3). In order to obtain the predicted cycle time, there is a need to know the finish time point of the return waveform. However, when the return waveform generation unit 28 of the controller 2 according to the first embodiment generates the return waveform in advance before the time chart is executed, the return waveform or the finish time point is acquired through the interface 20 and the interface 81, thereby being capable of displaying the predicted cycle time on the time chart creation device 8 side.

### <Operation of Device Control System According to Second Embodiment>

Subsequently, the operation of the device control system 1 according to this embodiment will be described with an example of a specific time chart.

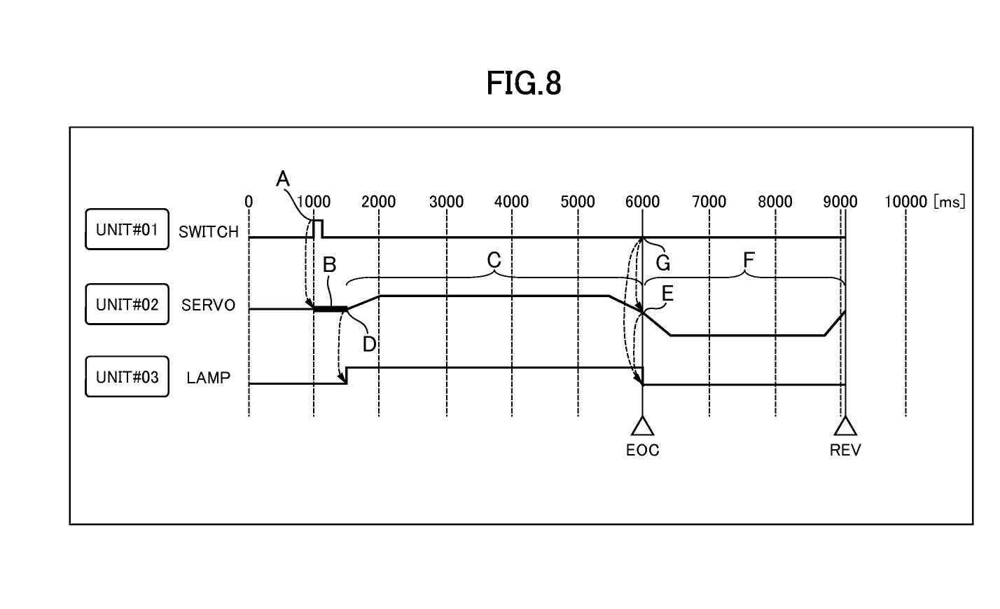

Similarly, in this embodiment, it is assumed that the user creates the same time chart as that illustrated in FIG. 4. When the user gives an instruction on the creation finish of the time chart, or gives an instruction on automatic generation of the return waveform, an addition of the return waveform by the return waveform generation unit 82e, an addition of a regression instruction by the regression instruction generation unit 82f, and an addition of a contact initialization instruction by the contact initialization instruction generation unit 82g are conducted on the time chart. FIG. 8 is a time chart in which the return waveform, the regress instruction, and the contact initialization instruction are added.

A waveform shown in a zone F of the figure is the return waveform. The start time point of the return waveform is after the finish time point (EOC in the figure) designated by the user, and a time point when the states of the respective devices are the finish state is selected. In this example, because both of the finish time point of the time chart, and the finish time point of the operation of the linear slider 5 which is the servo axis are 6000 ms, 6000 ms is also selected as the start time point of the return waveform. To make the start of the return waveform be linked to another device, preferably, the finish states of all of the other input devices and servo axes, enables that the return operation can start in the real operation under the condition where the other devices are in the finish state. In an example shown in the figure, the start time point of the return waveform is linked with that the switch 6 is in the off state which is the finish state (point G in the figure). Also, the regression instruction (REV in the figure) is added to the finish time point of the return waveform. Further, a signal that turns off the lamp 7 is added with a link between that the switch 6 is off at the finish time point (point G), and that the operation of the servo axis is finished (point E). This corresponds to the contact initialization instruction. In this way, to make an instruction for bringing the output contact into the initial state be linked with the finish state of another device enables that the contact initialization operation can be conducted after the operation on the time chart explicitly created by the user has been finished. A time chart illustrated in FIG. 8, that is, a time chart in which the return waveform, the regression instruction, and the contact initialization instruction are automatically generated, and added is transferred. Also, the predicted cycle time in this situation is predicted as 9100 ms which is a time when the regression instruction is added.

The real operation of executing the time chart of FIG. 8 by the device control system 1 according to this embodiment is identical with, for example, that illustrated in FIG. 5. That is, as illustrated in FIG. 5, the operation of the respective devices described in the time chart illustrated in FIG. 8 is interpreted, and sequentially executed by the time chart execution unit 25 of the controller 2. Then, as illustrated in FIG. 5, at a stage where the internal time arrives at 6000 ms, the operation of the linear slider 5 is assumed not to be finished.

In this case, the time chart illustrated in FIG. 8 is described so that the return operation of the servo axis, and the contact initialization operation, that is, the turn-off of the lamp 7 is conducted at the time point of 6000 ms. However, because the last operation in the servo axis is not finished, and the operation of the servo axis which is the operation of the link destination of the lamp 7 is not finished, both of those operations are not executed. At the time point when the internal time reaches the time point E when the operation of the servo axis is finished, and the positioning completion signal is output, the return operation starts, and at the same time, the lamp 7 turns off.

The above operation so far is conducted by the time chart execution unit 25 executing the time chart. Then, in this embodiment, the regression instruction described at the time point of 9100 ms on the time chart illustrated in FIG. 8 indicates the finish position of the operation described in the time chart. Therefore, the time chart finish determination unit 26 determines that the operation described in the time chart has been finished with the finish of the real operation of the respective devices, after the time point of 9100 ms where the regression instruction is described. In the example of FIG. 5, since the return operation of the servo axis is finished at 9500 ms, the finish determination by the time chart finish determination unit 26 is conducted at the time point when the internal time is 9500 ms.

Then, the regression operation execution unit 30 executes the regression instruction, and turns the internal time back to Oms to repetitively execute the time chart. The time point of the regression operation is a time point indicated by REV in the figure. Similarly, in this embodiment, the regression operation execution unit 30 counts the number of regression operation, and finishes the control of the device if the number of regression operation reaches the designated number of regression operation.

Also, a real time from a time (Oms in the internal time) when the execution of the time chart starts to a time (9500 ms in the internal time in this case) when the regression operation is executed is measured by the measured cycle time measurement unit 31, and output the measured real time to the time chart creation device 8 through the interface 20. Similarly, in this embodiment, if the override coefficient is 1, the measured cycle time is 9500 ms.

In this embodiment, as described above, since the time chart creation device 8 automatically generates the return waveform and the contact initialization instruction, and adds the generated return waveform and contact initialization instruction to the time chart, the user easily repeats the sequence of operation described in the time chart without particularly being aware of the states of the respective devices at the time of finishing the time chart. Also, since the return waveform and the contact initialization instruction can be displayed on the time chart creation device 8 side, the user can confirm the return operation and the contact initialization operation. Further, the predicted cycle time including the return operation can be known before the respective devices actually operate. Also, when the number of regression operation is designated, the time chart is repetitively executed by an arbitrary number of times.

### <Operation Flow of Time Chart Creation Device According to Second Embodiment>

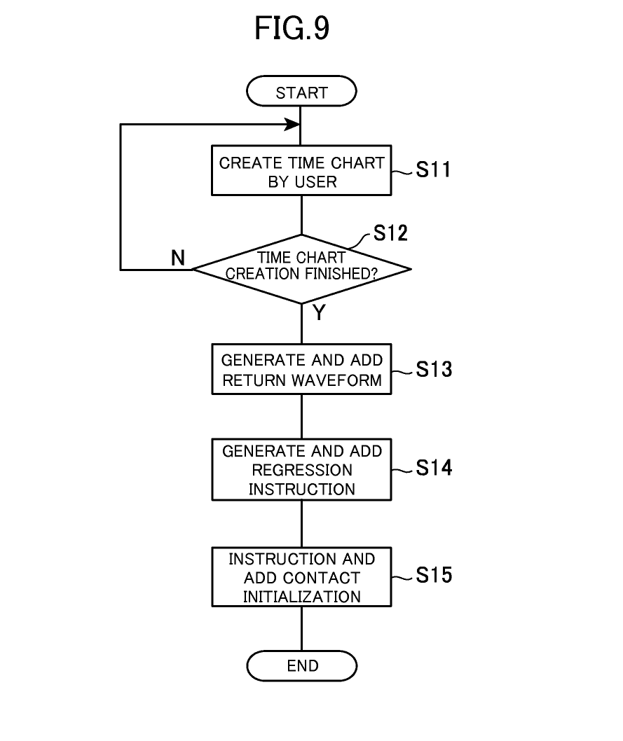

FIG. 9 is a flowchart illustrating operation when the time chart creation device 8 according to this embodiment creates the time chart.

The time chart creation device 8 creates the time chart according to an instruction from the user in Step S11. Step S11 includes the creation of the velocity/position chart, the creation of input/output chart, the setting of the finish time, the designation of the number of regression operation, and the designation of the initial position.

The operation in Step S11 is repetitively executed until the user gives an instruction on the creation finish of the time chart.

In Step S12, it is determined whether the creation finish instruction of the time chart from the user is present, or not, and the operation returns to Step S11 if there is no creation finish instruction.

If there is the creation finish instruction of the time chart from the user, the operation proceeds to Step S13, the return waveform is generated and added to the time chart. In subsequent Step S14, the regression instruction is generated, and added to the time chart. In further subsequent Step S15, the contact initialization instruction is generated, and added to the time chart.

With the above operation, the time chart creation device 8 creates the time chart including the return waveform, the regression instruction, and the contact initialization instruction.

<Operation Flow of Controller according to Second Embodiment>

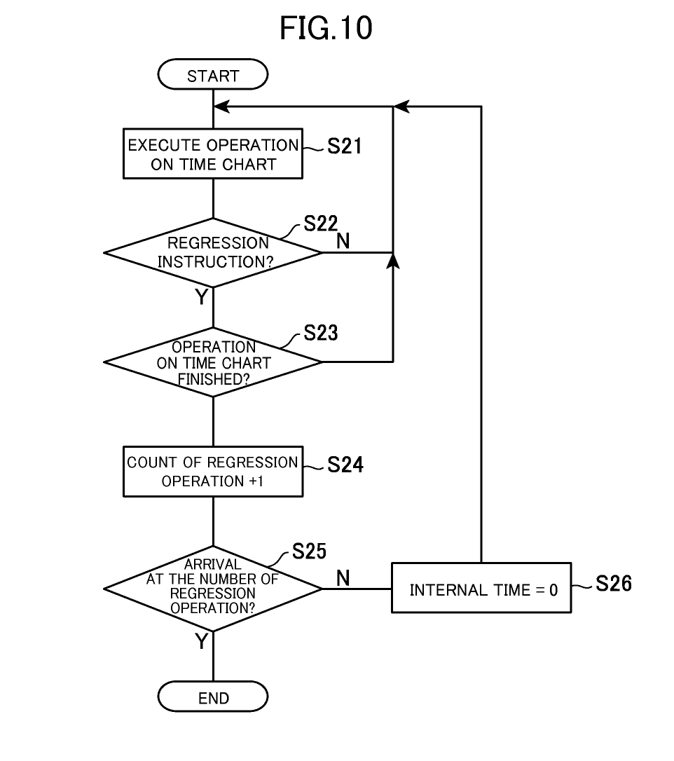

FIG. 10 is a flowchart illustrating operation when the controller 2 according to this embodiment executes the time chart.

When starting the execution of the time chart, the controller 2 interprets and executes the operation described in the time chart according to the internal time in Step S21. Then, the controller 2 proceeds to Step S22.

In Step S22, the controller 2 determines whether the internal time arrives at the time of the regression instruction, or not. If not, the controller 2 progresses the internal time, and returns to Step S21, and if yes, the controller 2 proceeds to Step S23. Then, the controller 2 determines whether the operation on the time chart is finished, or not. That is, because the state of the input contact matches the state at the finish time of the time chart, and the servo axis outputs the positioning completion signal, the controller 2 determines that the operation on the time chart is finished. If the operation on the time chart is not finished, the controller 2 returns to Step S21, and if the operation is finished, the controller 2 proceeds to Step S24.

In this embodiment, because the time chart includes the return waveform and the contact initialization instruction, the time point of the regression instruction becomes the finish time point of the operation on the time chart. Therefore, in the above-mentioned Steps S22 and S23, the controller 2 determines whether the operation described in the time chart is finished, or not.

In Step S24, the count of the regression operation is incremented by 1. In subsequent Step S25, if this count does not arrive at the designated number of regression operation, the controller 2 proceeds to Step S26, resets time to 0 ms through the internal time, and further returns to Step S21 to repeat the execution of the time chart. If the count arrives at the number of regression operation, the controller 2 finishes the operation.

In the controller 2 according to the second embodiment as described above, the return waveform and the contact initialization instruction which are generated by the time chart creation device 8 are executed by the time chart execution unit 25 as in the operation created by the user. Alternatively, in this embodiment, as with the controller according to the first embodiment, the return waveform and the contact initialization instruction maybe executed with the provision of the return operation execution unit/contact initialization unit 27 (refer to FIG. 3). The return waveform, the contact initialization instruction, and the operation created by the user may be distinguishable by addition of information indicative of the return waveform or the contact initialization instruction to the respective operation, or may be distinguished by before or after the finish time set by the user. When the return operation and the contact initialization operation are conducted by the return operation execution unit/contact initialization unit 27, the return waveform and the contact initialization instruction do not always need to be linked with the finish state of another device.

Also, in the above description, the control of the device is finished at the time point of the regression instruction when the number of regression operation arrives at the designated number of regression operation. Alternatively, as in the first embodiment, the control of the device may be finished at the time point when the operation explicitly shown in the time chart by the user is finished.

The configurations of the respective embodiments as described above have been described as the specific examples, and the invention disclosed in the present specification is not limited to the configuration per se of those specific examples. Those skilled in the art may variously modify the embodiments disclosed therein, for example, may appropriately change the respective members, or shapes, numbers, and arrangements of their portions, and also may replace the control illustrated in the flowcharts with another control having the same functions. The technical scope of the invention disclosed in the present specification should be understood to include those modifications.

In other words, it should be understood by those skilled in the art that various modifications, combinations, sub-combinations and alternations may occur depending on design requirements and other factors insofar as they are within the scope of the appended claims or the equivalents thereof.

What is claimed is:

1. A controller that controls a device on the basis of a time chart, which
controls a servo axis on the basis of a velocity chart that plots a velocity of the servo axis and/or a position chart that plots a position of the servo axis, with respect to a time axis;
executes return operation for returning the servo axis to an initial position set in the time chart in advance after operation described in the time chart has been executed; and
executes regress operation for regressing to a start point of the time chart, and repetitively executing the time chart after the return operation has been completed.

2. The controller according to claim 1,
wherein the controller automatically generates and executes the return operation on the basis of specified velocity and acceleration of the servo axis.

3. The controller according to claim 2,
wherein the controller further automatically generates and executes the return operation on the basis of a present position of the servo axis.

4. The controller according to claim 1,
wherein the initial position is set independent of an origin position of the servo axis.

5. The controller according to claim 1,
wherein the return operation is executed under at least one condition that a positioning completion signal of the servo axis is output in operation described in the time chart.

6. The controller according to claim 1,
wherein the regression operation is executed under at least one condition that a positioning completion signal of the servo axis is output in the return operation.

7. The controller according to claim 1,
wherein an output signal of an output contact is put into an initial state after the operation described in the time chart has been implemented.

8. A time chart creation device that creates a time chart describing the operation of the controller according to claim 1, comprising:
a velocity/position chart creation unit configured to create the velocity chart and/or the position chart; and
an initial position designation unit configured to designate the initial position with respect to the servo axis.

9. The time chart creation device according to claim 8, further comprising: a return waveform generation unit configured to generate a return waveform which is a waveform of the return operation at specified velocity and acceleration with respect to the servo axis.

10. The time chart creation device according to claim 8, further comprising: a return waveform display unit configured to display the return waveform in the velocity chart and/or the position chart.

11. The time chart creation device according to claim 8, further comprising: a predicted cycle time display unit configured to display a predicted cycle time which is a time from a start time of the time chart to finish of the regression operation.

12. The time chart creation device according to claim 8,
wherein the controller measures a measured cycle time which is a time from a start time of the time chart to an execution time of the regression operation for each execution of the time chart, and
wherein the time chart creation device includes a measured cycle time display unit configured to display the measured cycle time.

13. The time chart creation device according to claim 8, further comprising: a regression number designation unit configured to designate the number of regression operation.

14. A tangible computer readable information storage medium, which stores a computer program causing a computer to function as the time chart creation device according to claim 8.

15. A device control method for controlling a device on the basis of a time chart, comprising:
controlling a servo axis on the basis of a velocity chart that plots a velocity of the servo axis and/or a position chart that plots a position of the servo axis, with respect to a time axis;
executing return operation for returning to an initial position set in the time chart in advance after operation described in the time chart has been executed; and
executing regress operation for regressing to a start point of the time chart, and repetitively executing the time chart after the return operation has been completed.

16. A time chart creating method that creates a time chart describing the operation of the controller according to claim 1, comprising:
creating the velocity chart and/or the position chart, and
designating the initial position with respect to each servo axis.
